(19) United States
(12) Patent Application Publication
(10) Pub. No.: US 2011/0123160 A1
(43) Pub. Date: May 26, 2011

(54) DUAL FLOOR DENSED FIBER OPTIC ARRAY

(76) Inventors: Moshe Liberman, Rishon-LeZion (IL); Itzhak Gidanian, Gan Yavneh (IL); Moti Klap, Netanya (IL)

(21) Appl. No.: 12/624,438

(22) Filed: Nov. 24, 2009

(51) Int. Cl. G02B 6/04

(52) U.S. Cl. 385/115; 264/1.28

(57) ABSTRACT

A fiber optic mechanical structure (104) including a substrate configured with plurality of grooves wherein the grooves are split into a first grooves slots and a second grooves slots. A first group of plurality of fibers is placed on the substrate (204) wherein the jackets of one end of each of the first group of plurality of fibers (404) is removed (208) and are secured in the first grooves slots (416). A second group of plurality of fibers (408) is placed on the first group of plurality of fibers (404) wherein the jackets of one end of each of the second group of plurality of fibers is removed and are secured in the second grooves slots (420).

### FIELD OF THE INVENTION

The present invention relates to a method and apparatus of making a fiber optic array, and more particularly, to a method of making an array which has an increased packing density.

### BACKGROUND OF THE INVENTION

It is known in the prior art to use an array of optical fibers in a print head which is used to record information on a light-sensitive recording medium. The fibers can be arranged with their output ends in a linear array extending in a direction transverse to the direction of movement of the recording medium. A light source, such as a light-emitting diode or a diode laser, is connected to each of the fibers at an input end. The light in each of the fibers is modulated in accordance with an information signal to produce a desired image. Focusing means can be used in front of each fiber to cause the light to be focused to a point on the recording medium.

It is desirable for the arrays of optical fibers to have a high packing density, i.e., a high number of fibers per unit width of the array, in order to limit the amount of data buffering needed to produce the output image. There is a problem, however, in using increasingly thinner fibers to increase the packing density. As the fibers are made thinner, handling and alignment of the fibers becomes more difficult, and the thinner fibers are more likely to break in the assembly process.

In U.S. Pat. No. 4,389,655 an optical device is disclosed for non-impact recording in which the recording head includes a linear array of optical fibers. The recording head comprises an adjustment plate having a plurality of grooves therein, and an optical fiber is secured in each of the grooves. In one embodiment of the invention, the fibers have been arranged in grooves which converge toward the output end of the array to closely space the output ends of the fibers. In another embodiment, one row of fibers is arranged above another row, and the fibers in the top row are offset relative to the fibers in the bottom row. In both of these embodiments, however, the packing density of the fibers is limited by the relatively large diameter of the fibers at their output ends.

### SUMMARY OF THE INVENTION

Briefly, according to one aspect of the present invention a fiber optic mechanical structure includes a substrate configured with plurality of grooves wherein the grooves are split into odd grooves slots and even grooves slots. A first group of plurality of fibers is placed on the substrate wherein the jackets of one end of each of the first group of plurality of fibers is removed and are secured in the odd grooves slots. A second group of plurality of fibers is placed on the first group of plurality of fibers wherein the jackets of one end of each of the second group of plurality of fibers is removed, and the fibers are secured in the even grooves slots.

These and other objects, features, and advantages of the present invention will become apparent to those skilled in the art upon a reading of the following detailed description when taken in conjunction with the drawings wherein there is shown and described an illustrative embodiment of the invention.

### BRIEF DESCRIPTION OF THE DRAWINGS

FIG. 1 shows a cross sectional view of a prior art fiber mechanical assembly such as a v-groove array with arranged fibers;

FIG. 2 shows a top view of a prior art fiber optic array showing a plurality of fibers with a cladding exposed end placed on a fiber mechanical assembly;

FIG. 3 shows a perspective view of a prior art fiber optic array showing a plurality of fibers with a cladding exposed end placed on a fiber mechanical assembly;

FIG. 4 shows a cross sectional view of fiber mechanical assembly array arranged in two floors of fibers;

FIG. 5 shows a top view of a two floors fiber optic array arrangement;

FIG. 6 shows a side view of a two floors fiber optic array arrangement; and

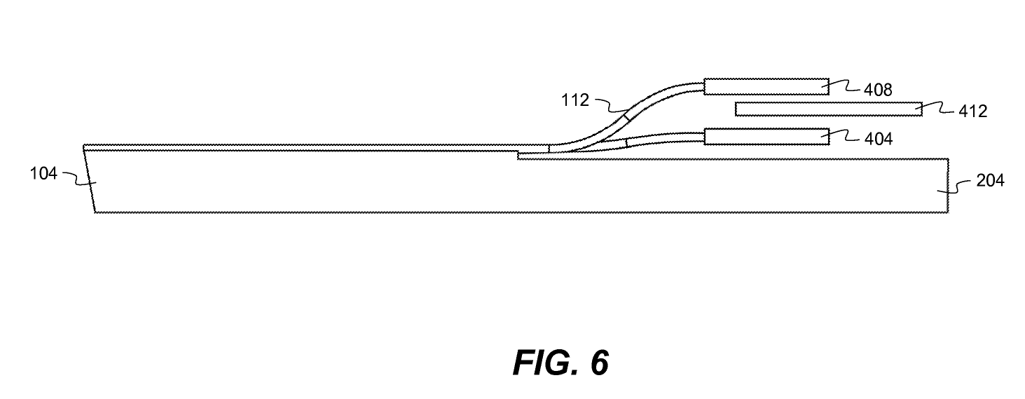

FIG. 7 shows perspective view of a two floors fiber optic array arrangement.

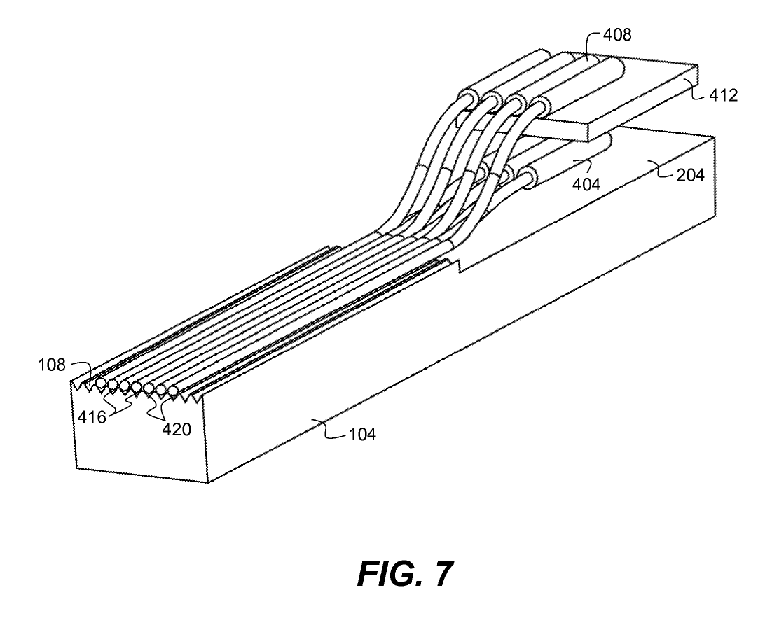

### DETAILED DESCRIPTION OF THE INVENTION

In the following detailed description, numerous specific details are set forth in order to provide a thorough understanding of the disclosure. However, it will be understood by those skilled in the art that the teachings of the present disclosure may be practiced without these specific details. In other instances, well-known methods, procedures, components and circuits have not been described in detail so as not to obscure the teachings of the present disclosure.

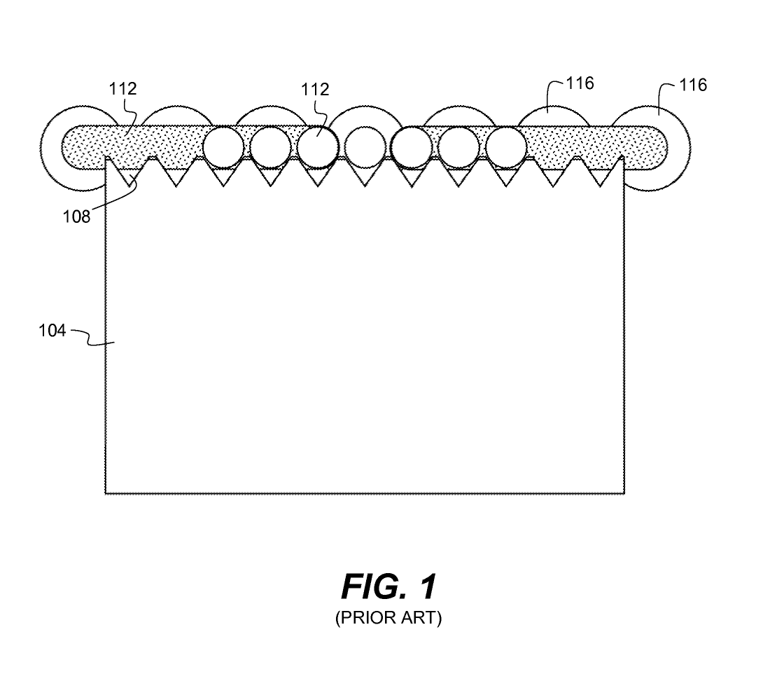

The present invention describes an optical head configuration using plurality of fibers. The optical head uses fibers with exposed jacket 112 on a portion of the fibers (shown in FIG. 1). The exposed fibers are arranged in grooves 108 inside a groove array 104. A typical diameter of such a fiber cord with a jacket is about 250 micro meters (microns). The exposed fiber ends 112 are placed in grooves 108, forming a pitch of 140 microns between the grooves 108. The diameter of the exposed fiber ends is usually about 125 microns.

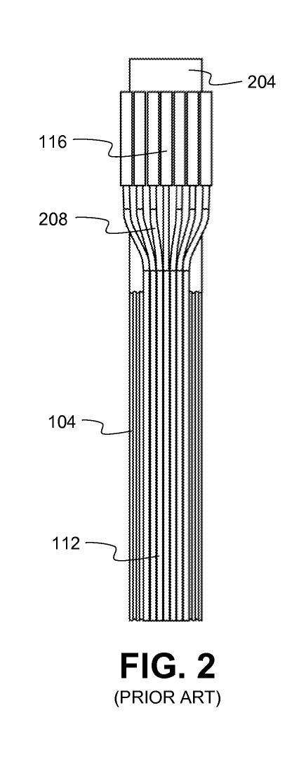

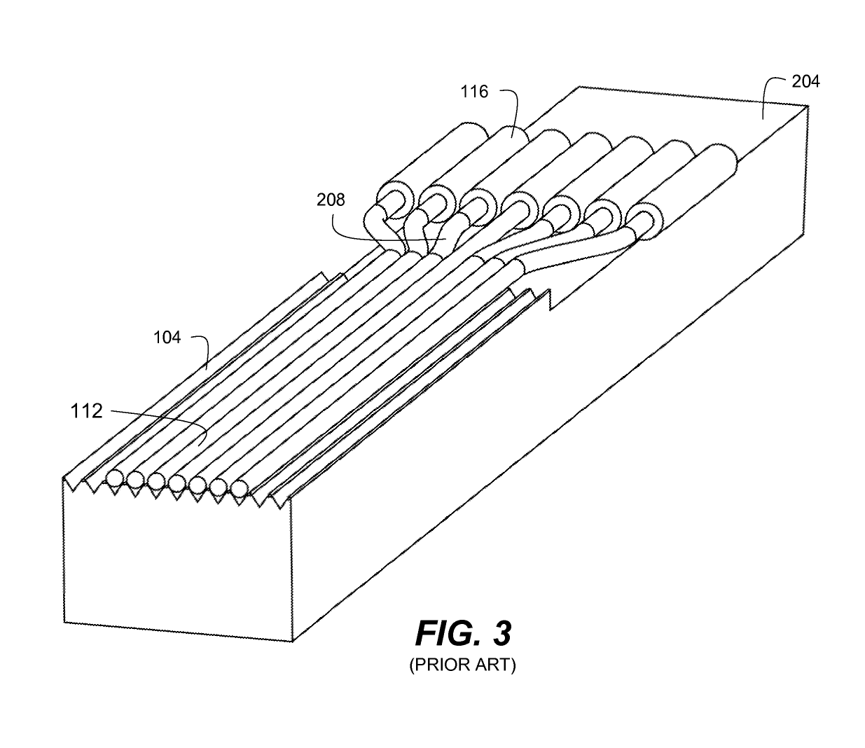

The difference in the diameters of fiber portion 116 (250 microns) and fiber portion 112 (125 microns) creates difficulties in arranging fibers portion 116 in an economical manner on stage 204. This is demonstrated in FIG. 2, by showing the lack of room to properly arrange the fibers extended from stage to vgroove 208. This difference causes a complicated configuration of the fiber head as is shown in FIGS. 1, 2, and 3. The proposed invention suggests a solution for overcoming the problem described above.

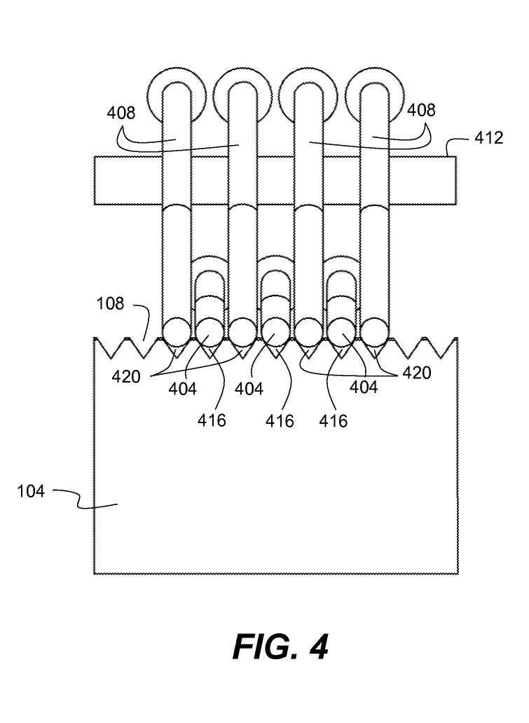

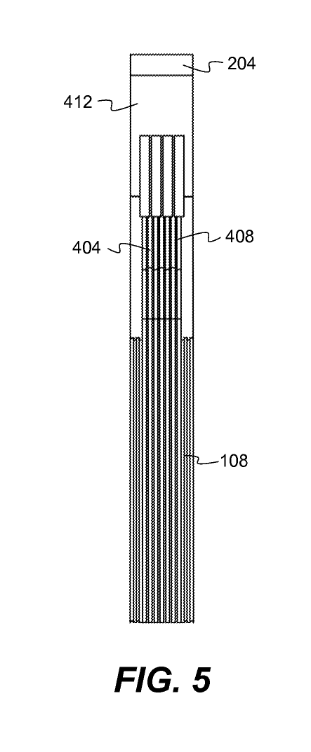

FIGS. 4, 5 ,6, and 7 show a dual floor configuration adapted to properly arrange fiber portions 116 on stage 204. A first group of fibers 404 with the jacket portion is placed on stage 204 and is secured to stage 204. A separator stage 412 is placed on top of the first group of fibers 404. A second group of fibers (with the jacket portion) is placed on separator stage 412 and is secured to it. The exposed ends 112 from fibers groups 404 and 408 are guided into grooves 108. Typically the fibers from group 404 will be led into the slots 416 of the grooves (e.g. second, fourth and such grooves), and those that originated from fiber group 408 are led into the slots 420 of the grooves (e.g. first, third and such grooves). This configuration offers a much more economical fibers arrangement in term of space usage, and therefore a more efficient optical head structure.

The invention has been described in detail with particular reference to certain preferred embodiments thereof, but it will be understood that variations and modifications can be effected within the scope of the invention.

### PARTS LIST

104 fiber mechanical assembly array (such as vgroove)
108 grooves in vgroove
112 fibers exposed cladding portion
116 fibers jacket portion
204 fibers stage
208 fibers extended from stage to vgroove
404 first group of fibers
408 second group of fibers
412 separator stage between first group and second group
416 first grooves slot
420 second grooves slot

1. A method of making a fiber optic array comprising the steps of:
a) forming a plurality of grooves in a substrate;
b) removing a jacket cover from a distal end of each of a plurality of optical fibers;
c) dividing said plurality of optical fibers into at least two groups, a first group and a second group;
d) placing the fibers jacket portion of said first group of fibers on a stage;
e) securing said fibers jacket portion of first group to said stage;
f) cementing said distal end of said first group of fibers into a first group of grooves selected from said plurality of grooves;
g) placing the fibers jacket portion of said second group of fibers above said first group of fibers on said stage;
h) securing said second group to said first group; and
i) cementing said distal end of said second group of fibers into a second group of grooves selected from said plurality of grooves.

2. The method in claim 1 wherein each of said first group of fibers and said second group of fibers comprises an equal number of fibers.

3. The method in claim 1 wherein each of said first group of grooves and said second group of grooves comprises an equal number of grooves.

4. The method in claim 1 wherein the grooves of said first group of grooves are selected from even numbered positions of said plurality of grooves.

5. The method in claim 1 wherein the grooves of said first group of grooves are selected from odd numbered positions of said plurality of grooves.

6. The method in claim 1 wherein the grooves of said second group of grooves are selected from even numbered positions of said plurality of grooves.

7. The method in claim 1 wherein the grooves of said second group of grooves are selected from odd numbered positions of said plurality of grooves.

8. A fiber optic mechanical structure comprising:
a substrate configured with a plurality of grooves wherein said grooves are split into first grooves slots and a second grooves slots;
a first group of fibers is placed on said substrate wherein a distal end of each of said first group of fibers is unjacketed and secured in said first grooves slots; and
a second group of fibers is placed on said first group of fibers wherein a distal end of each of said second group of fibers is unjacketed and are secured in said second grooves slots.
